(19) United States
(12) Patent Application Publication
(10) Pub. No.: US 2025/0210246 A1
(43) Pub. Date: Jun. 26, 2025

(54) PRINTED CIRCUIT BOARD TRANSFORMER INTEGRATING LITZ WIRE

(71) Applicant: VIRGINIA TECH INTELLECTUAL PROPERTIES, INC., Blacksburg, VA (US)

(72) Inventors: Zheqing Li, Blacksburg, VA (US); Qiang Li, Blacksburg, VA (US); Fred C Lee, Blacksburg, VA (US); Eric Hsieh, Christiansburg, VA (US)

(21) Appl. No.: 18/989,411

(22) Filed: Dec. 20, 2024

Related U.S. Application Data
(60) Provisional application No. 63/612,826, filed on Dec. 20, 2023.

(51) Int. Cl. H01F 27/28; H01F 27/24

(52) U.S. Cl. CPC H01F 27/2804; H01F 27/24; H01F 2027/2809

(57) ABSTRACT

An example winding structure for a printed circuit board (PCB) transformer includes a circular winding region defined by an outer circumference and an inner circumference, a first plurality of strand sections in a first conductive layer, and a second plurality of strand sections in a second conductive layer. Each strand section of the first plurality of strand sections extends from the outer circumference to the inner circumference, and each strand section of the second plurality of strand sections extends from the outer circumference to the inner circumference. The winding structure further includes a plurality of vias that connects the first plurality of strand sections to the second plurality of strand sections to form a single strand through the circular winding region.

### CROSS-REFERENCE TO RELATED APPLICATION

This application claims the benefit of and priority to U.S. Provisional Patent Application No. 63/612,826, filed Dec. 20, 2023, entitled “PRINTED CIRCUIT BOARD WINDING DESIGN WITH PRINTED CIRCUIT BOARD LITZ CONCEPT,” the entire content of which is hereby incorporated herein by reference in its entirety.

### BACKGROUND

Many electronic devices and systems rely upon power at a well-regulated, constant, and well-defined voltage for proper operation. In that context, power conversion devices and systems are relied upon to convert electric power or energy from one form to another. A power converter is an electrical or electro-mechanical device or system for converting electric power or energy from one form to another. As examples, power converters can convert alternating current (AC) power into direct current (DC) power, convert DC power to AC power, provide a DC to DC conversion, provide an AC to AC conversion, change or vary the characteristics (e.g., the voltage rating, current rating, frequency, etc.) of power, or offer other forms of power conversion. A power converter can be as simple as a transformer, but many power converters have more complicated designs and are tailored for a variety of applications and operating specifications.

Printed circuit board (PCB) winding magnetic components present a promising concept to increase the power density of a power converter, improve the electromagnetic interference (EMI) performance, reduce costs, and enhance manufacturability. They are widely utilized for a transformer and inductor designs in DC-DC and AC-DC power conversion applications such as data centers, electric vehicle (EV) charging, telecom, and energy storage systems.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 depicts an example winding structure for a PCB transformer according to various embodiments of the present disclosure.

FIG. 2 depicts another example winding structure for a PCB transformer according to various embodiments of the present disclosure.

FIG. 3 depicts an implementation of the example winding structure shown in FIG. 2 with multiple strands according to various embodiments of the present disclosure.

FIG. 4 depicts a further implementation of the example winding structures shown in FIGS. 2 and 3 according to various embodiments of the present disclosure.

FIG. 5 depicts an example winding structure implementing multiple turns for a PCB transformer according to various embodiments of the present disclosure.

FIG. 6 depicts an example winding structure implementing multiple turns for a single strand according to various embodiments of the present disclosure.

FIG. 7 depicts an example winding structure implementing multiple turns in multiple layers according to various embodiments of the present disclosure.

### DETAILED DESCRIPTION

Printed circuit board (PCB) winding magnetic components present a promising concept to increase the power density of a power converter, improve the electromagnetic interference (EMI) performance, reduce costs, and enhance manufacturability. They are utilized for transformer and inductor designs in DC-DC and AC-DC power conversion applications, such as data centers, electric vehicle (EV) charging, telecom, and energy storage systems. However, PCB transformers including PCB winding transformers can face limitations in terms of high winding loss. Unlike a traditional Litz wire, PCB windings can lack interwoven stranded wires that mitigate the skin effect (e.g., AC may not penetrate deeply into conductors due to eddy currents induced in the material and may tend to flow near the surface) and proximity effect (e.g., current crowding) at high frequencies, resulting in increased winding loss.

Despite the comparable thickness of a PCB winding to the skin depth at an operating frequency, a wide winding width can lead to uneven current distribution horizontally. This issue can become more pronounced with wider copper widths for higher currents, thereby restricting the feasibility of utilizing PCB winding transformers for higher power applications. To provide an example, for a solid-state transformer (SST) where medium voltage (MV) insulation is necessary, this limitation is exacerbated as limited interleaving can be employed to reduce AC winding losses in PCB winding transformers.

Emulating Litz wire is an attractive option to achieve improved current distribution and reduced winding loss in high power applications such as SSTs. For example, some conventional concepts arrange strands in a zig-zag pattern within a rectangular PCB winding, thereby achieving a Litz wire-like effect. However, implementing a Litz wire in a PCB presents challenges due to its complex construction. To maintain consistent impedance among the strands, each strand must be designed with the same length. Additionally, optimizing the winding area and core area can become a coupled process, as a larger winding area can necessitate a larger core to accommodate the winding, thereby limiting optimization flexibility. Furthermore, the intricate winding structure of individual strands can make it impractical to complete the layout of a PCB Litz wire.

Another conventional method attempts to construct a PCB Litz wire using a braid-like pattern. However, this approach resulted in all turns being in the same layers, which increases the footprint of multi-turn transformers. Another conventional method proposed a multiple-layer solution by connecting each layer from the terminals in the rectangular winding. However, this method is not suitable for SST applications since all windings need to be connected inside the insulation layer rather than outside the insulation layer. Still, other conventional methods experience issues such as significant current crowding, resulting in additional losses.

In the context outlined above, various embodiments of the present disclosure are directed to integrating a Litz wire in a PCB or planar transformer. In one example, a winding structure for a printed circuit board (PCB) transformer includes a circular winding region defined by an outer circumference and an inner circumference, a first plurality of strand sections in a first conductive layer, and a second plurality of strand sections in a second conductive layer. Each strand section of the first plurality of strand sections extends from the outer circumference to the inner circumference, and each strand section of the second plurality of strand sections extends from the outer circumference to the inner circumference. The winding structure further includes a plurality of vias that connects the first plurality of strand sections to the second plurality of strand sections to form a single strand through the circular winding region.

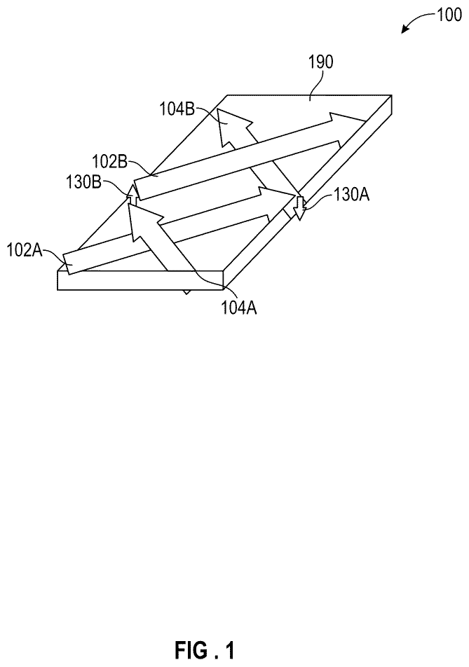

Referring now to the drawings, FIG. 1 depicts an example winding structure for a PCB transformer according to various embodiments of the present disclosure. A winding structure 100 includes a substrate or winding region 190, a first plurality of strand sections including individual strand sections 102A and 102B, a second plurality of strand sections including individual strand sections 104A and 104B, and vias 130A and 130B.

The winding structure 100 shown in FIG. 1 is not exhaustively illustrated, meaning that other components not shown in FIG. 1 can be included or relied upon in some cases. Similarly, one or more components shown in FIG. 1 can be omitted in some cases. The individual strand sections 102A and 102B are each in a first conductive layer across the winding region 190. The individual strand sections 104A and 104B are each in a second conductive layer across the winding region 190. In other words, the strand sections 102A and 102B are parts of the first conductive layer, and the strand sections 104A and 104B are parts of the second conductive layer, across the winding region 190. The winding region 190 can include one or more PCB layers and be embodied as FR-4, according to one example. The vias 130A and 130B can be embodied as through-hole vias or buried vias, according to one or more examples.

The vias 130A and 130B are configured to connect the first plurality of strand sections to the second plurality of strand sections or the first conductive layer to the second conductive layer. As depicted and according to one example, the strand section 102A extends from a top side and left lateral edge of the winding region 190 to a top side and right lateral edge of the winding region 190. The strand section 102A can connect to the strand section 104B through the via 130A, and the strand section 104B extends from a bottom side and right lateral edge of the winding region 190 to a bottom side and left lateral edge of the winding region 190. The strand section 102A and the strand section 104B can form a single strand that includes two conductive layers by use of the via 130A.

The strand section 104A extends from a bottom side and right lateral edge of the winding region 190 to a bottom side and left lateral edge of the winding region 190. The strand section 104A can connect to the strand section 102B through the via 130B, and the strand section 102B extends from a top side and left lateral edge of the winding region 190 to a top side and right lateral edge of the winding region 190. The strand section 104A and the strand section 102B can form a single strand that includes two conductive layers by use of the via 130B. The two strands described above can form one turn and by adopting a zig-zag pattern as depicted, an interwoven structure can be attained, facilitating a more even current distribution for the winding structure 100.

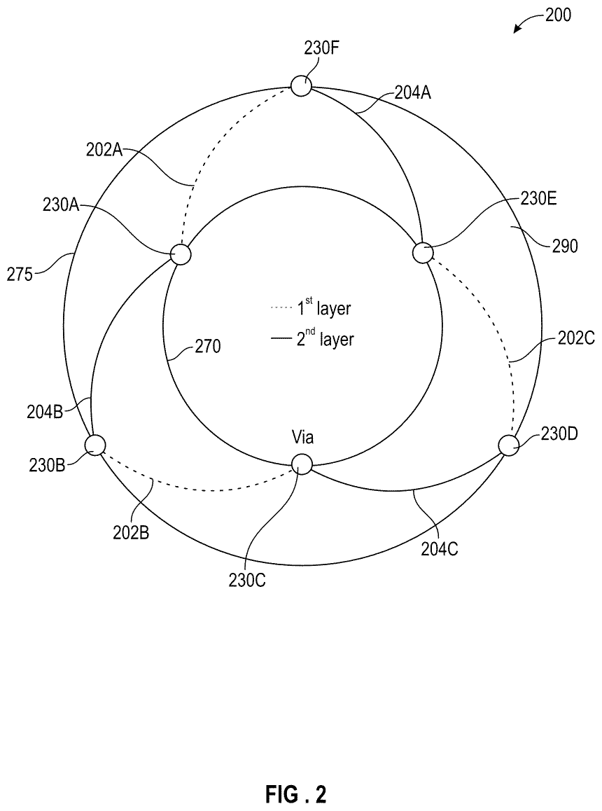

A primary side winding loss can be unevenly distributed for a PCB transformer and is usually a limiting factor in improving efficiency and thermal performance. In conventional approaches, high power applications often utilize Litz wire to achieve balanced current distribution. In the example described above with respect to FIG. 1, multiple strand sections or strands are interwoven together, with each having a diameter lower than the skin depth to ensure even current distribution per strand. The interweaving of all strands helps to mitigate the proximity effect among bundles. The length of lay, which refers to the distance one strand completes its rotation around the Litz wire circumference, can play an important role in determining the level of interweaving among strands. However, ensuring uniform current distribution for the winding structure 100 can require careful design of the length of each strand or strand section, which can be impractical in certain instances. To mitigate this potential limitation, additional winding structures according to the embodiments are provided with respect to FIGS. 2-7.

FIG. 2 depicts another example winding structure for a PCB transformer according to various embodiments of the present disclosure. A winding structure 200 includes a toroidal-type or circular winding region 290, a first plurality of strand sections including individual strand sections 202A, 202B, and 202C, a second plurality of strand sections including individual strand sections 204A, 204B, and 204C, and vias 230A-230F that can interconnect the first plurality of strand sections and the second plurality of strand sections. It should be noted that the winding structure 200 is not exhaustively illustrated, meaning that other components not shown in FIG. 2 can be included or relied upon in some cases. Similarly, one or more components shown in FIG. 2 can be omitted in some cases. The winding structure 200 can be integrated or implemented in a PCB or planar transformer. In a PCB transformer, for example, the winding structure 200 can be placed around a magnetic core such as a ferrite core, as available in the art.

The circular winding region 290 can include one or more PCB layers and can be embodied as FR-4 according to one example. The circular winding region 290 can include multiple conductive layers, which include the first plurality of strand sections and the second plurality of strand sections mentioned above. The circular winding region 290 is defined by an inner circumference 270 and an outer circumference 275. Each of the first plurality of strand sections and the second plurality of strand sections is arc-like, curved, or substantially arc-like in shape and extends from the inner circumference 270 to the outer circumference 275, or vice-versa. Each of the first plurality of strand sections including the individual strand sections 202A, 202B, and 202C is a part of a first conductive layer between the inner circumference 270 and the outer circumference 275. Each of the second plurality of strand sections including the individual strand sections 204A, 204B, and 204C is a part of a second conductive layer between the inner circumference 270 and the outer circumference 275. Additionally, each of the first plurality of strand sections including the individual strand sections 202A, 202B, and 202C and each of the second plurality of strand sections including the individual strand sections 204A, 204B, and 204C can be embodied as a single wire (e.g., copper wire) and as a part of the first conductive layer or the second conductive layer.

The first plurality of strand sections including the individual strand sections 202A, 202B, and 202C and the second plurality of strand sections including the individual strand sections 204A, 204B, and 204C can be interconnected or interwoven with each other by use of the vias 230A-230F, which can be embodied as through-hole vias or buried vias, according to one or more examples. Additionally, each of the individual strand sections 202A, 202B, and 202C and the individual strand sections 204A, 204B, and 204C extends from the inner circumference 270 to the outer circumference 275, or vice-versa, or from an inner edge of the circular winding region 290 to an outer edge of the circular winding region 290, or vice-versa.

As depicted in a loop-like or circular fashion, the strand section 202A is connected to the strand section 204B by use of the via 230A, the strand section 204B is connected to the strand section 202B by use of the via 230B, the strand section 202B is connected to the strand section 204C by use of the via 230C, the strand section 204C is connected to the strand section 202C by use of the via 230D, the strand section 202C is connected to the strand section 204A by use of the via 230E, and the strand section 204A is connected to the strand section 202A by use of the via 230F. This interconnection of the first plurality of strand sections including the individual strand sections 204A, 204B, and 204C and the second plurality of strand sections including the individual strand sections 204A, 204B, and 204C by use of the vias 230A-230F can form a single strand extending between the inner circumference 270 and the outer circumference 275 in an alternating manner as depicted.

It should be noted that matching strand sections, albeit corresponding to different conductive layers, are symmetrical with each other in a mirrored fashion. For example, the strand section 202A is symmetrical with the strand section 204A in a mirrored fashion or configuration about a radial axis intersecting the circular winding region 290 or with respect to the center of the circular winding region 290. Similarly, the strand section 204B is symmetrical with the strand section 202B, and the strand section 204C is symmetrical with the strand section 202C, in a mirrored fashion or configuration.

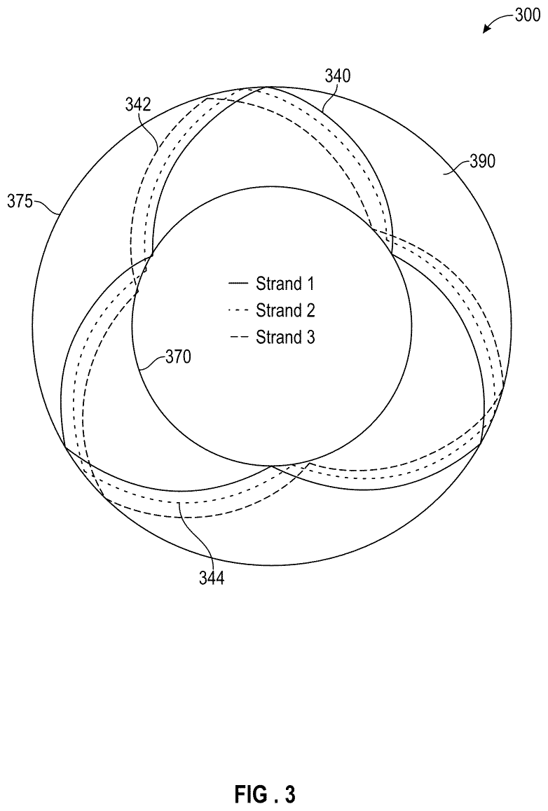

FIG. 3 depicts an implementation of the example winding structure shown in FIG. 2 with multiple strands according to various embodiments of the present disclosure. A winding structure 300 is similar to the winding structure 200 but includes three strands instead of one strand. The winding structure 300 includes a toroidal or circular winding region 390 which is defined by an inner circumference 370 and outer circumference 375. The winding structure 300 includes strand 340, strand 342, and 342. Three strands are depicted for the winding structure 300 for exemplary purposes only, and it should be noted that the winding structure 300 can include greater than three strands. For example, the winding structure 300 can include as many strands as feasible to substantially fill or cover an entire region or area of the circular winding region 390.

Each of the strands 340, 342, and 344 can correspond to a single strand as discussed with respect to the winding structure 200 in FIG. 2. For example, each of the strands 340, 342, and 344 include interconnection of multiple strand sections by vias (e.g., through-hole vias or buried vias), as described with respect to the winding structure 200 in FIG. 2. For example, each of the strands 340, 342, and 344 can include interconnection of six strand sections, with each strand section corresponding to an alternating conductive layer, as described with respect to the winding structure 200. The placement or spacing of each of the strands 340, 342, and 344 can be determined by the clearance requirement of the PCB manufacturing process. For example, with a 4 Oz thickness copper, the clearance should be maintained at 0.12 mm to 0.14 mm. The location of each of the strands 340, 342, and 344 between the inner circumference 370 and 375 can further be defined by a winding rotation angle θ₁. The winding rotation angle θ₁ can be defined by equation (1) below:

θ₁=2π/(N×M/2) (1).

For the winding rotation angle θ₁, N refers to the total number of strands in parallel at the circular winding region 390, and M refers to the total number of strand sections in each strand. In the example depicted in FIG. 3, each of the strands 340, 342, and 344 can be rotated from each other by the rotation angle θ₁, and N would equal 3 and M would equal 6 for the winding rotation angle θ₁. Each of the strands 340, 342, and 344 are parallel with each other, meaning that they are non-intersecting with each other at each respective conductive layer. The strands 340, 342, and 344 integrate a Litz wire or a PCB Litz wire for the winding structure 300.

The arc-like or curved structure of each strand section of a strand, as mentioned with respect to the winding structure 200 in FIG. 2, fully utilizes the copper space, resulting in lower DC winding resistance. Compared to other PCB Litz wire designs, the winding structures 200 and 300 exhibit infinite symmetric axes and demonstrate a center symmetric pattern. This feature provides an opportunity to maintain each wire at a natural and equal length by simply rotating one strand around the center of the circular winding region 290 or 390.

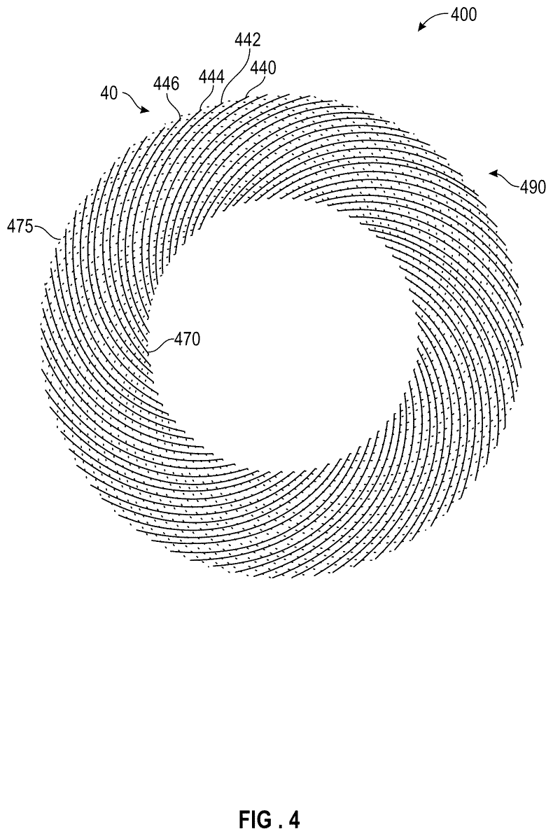

FIG. 4 depicts a further implementation of the example winding structures shown in FIGS. 2 and 3 according to various embodiments of the present disclosure. A winding structure 400 includes a similar structure to the winding structures 200 and 300 but includes a plurality of strands extending across an entirety of a space defined between an inner and outer circumference of a winding region. For example, the winding structure 400 includes a toroidal or circular winding region 490 which is defined by an inner circumference 470 and an outer circumference 475. The winding structure 400 includes a plurality of strands 40 that extends between the outer circumference 475 and the inner circumference 470 and substantially covers an entirety of a space defined by the inner circumference 470 and the outer circumference 475. The plurality of strands 40 includes strands 440, 442, 444, 446, and so forth (only four strands are labeled for simplicity purposes), each of which has a shape and structure similar to the strands 340, 342, or 344 for the winding structure 300 in FIG. 3.

Each of the plurality of strands 40 are rotated from each other by the winding rotation angle θ₁ and are parallel with each other between the inner circumference 470 and the outer circumference 475. For example, each of the strands 440, 442, 444, and 446 are parallel with each other and do not intersect with each other at corresponding conductive layers. In other words, for each strand, none of the strand sections corresponding to a first conductive layer intersect with each other, and none of the strand sections corresponding to a second conductive layer intersect with each other. The plurality of strands 40 substantially fill or encompass the entirety of the circular winding region 490 based on a rotation of each strand (e.g., the strand 440, 442, 444, or 446) by the winding rotation angle θ₁ and can form a PCB Litz wire pattern. Additionally, the plurality of strands 40 can form a single turn around a core of a PCB transformer.

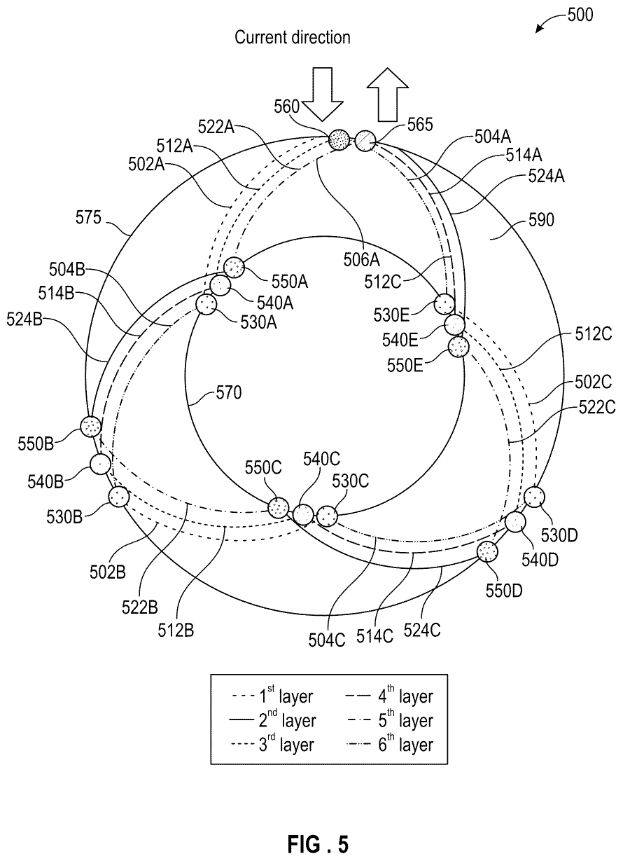

FIG. 5 depicts an example winding structure implementing multiple turns for a PCB transformer according to various embodiments of the present disclosure. A winding structure 500 offers additional advantages for multiple turns construction of one or more strands. Unlike conventional PCB Litz wire concepts, which struggle to change the Litz pattern to accommodate more vias, the winding structure 500 enables implementation of multiple turns for one or more strands using a similar rotation principle as outlined above for the winding structures 300 and 400, which used the winding rotation angle θ1.

The winding structure 500 includes a toroidal or circular winding region 590 which is defined by an inner circumference 570 and an outer circumference 575. The winding structure 500 also includes three turns of one or more strands with each turn corresponding to or forming two conductive layers between the inner circumference 570 and the outer circumference 575. Each turn is defined by strand sections, and strand sections for a turn can be interconnected by vias in a similar fashion as described with respect to the interconnection of the strand sections in the winding structures 100-400. A description of each turn and its connection of strand sections is provided below.

A first turn of the winding structure 500 includes a first plurality of strand sections including individual strand sections 502A, 502B, and 502C and a second plurality of strand sections including individual strand sections 504A, 504B, and 504C. Each of the individual strand sections 502A, 502B, and 502C is a part of a first conductive layer between the inner circumference 570 and the outer circumference 57. Each of the individual strand sections 504A, 504B, and 504C is a part of a second conductive layer between the inner circumference 570 and the outer circumference 575.

The strand section 502A can be configured to the strand section 504B by via 530A, the strand section 504B can be configured to connect to the strand section 502B by via 530B, the strand section 502B can be configured to connect to the strand section 504C by via 530C, the strand section 504C can be configured to connect to the strand section 502C by via 530D, and the strand section 502C can be configured to connect to the strand section 504A by via 530E. The connection of the first plurality of strand sections including the individual strand sections 502A, 502B, and 502C and the second plurality of strand sections including the strand sections 504A, 504B, and 504C as described above can form a single or first turn around a core of a PCB transformer.

A second turn of the winding structure 500 includes a third plurality of strand sections including individual strand sections 512A, 512B, and 512C and a fourth plurality of strand sections including individual strand sections 514A, 514B, and 514C. Each of the individual strand sections 512A, 512B, and 512C is a part of a third conductive layer between the inner circumference 570 and the outer circumference 575. Each of the individual strand sections 514A, 514B, and 514C is a part of a a fourth conductive layer between the inner circumference 570 and the outer circumference 575.

The strand section 512A can be configured to the strand section 514B by via 540A, the strand section 514B can be configured to connect to the strand section 512B by via 540B, the strand section 512B can be configured to connect to the strand section 514C by via 540C, the strand section 514C can be configured to connect to the strand section 512C by via 540D, and the strand section 512C can be configured to connect to the strand section 514A by via 540E. The connection of the third plurality of strand sections including the individual strand sections 512A, 512B, and 512C and the fourth plurality of strand sections including the strand sections 514A, 514B, and 514C as described above can form a single or second turn around a core of a PCB transformer.

A third turn of the winding structure 500 includes a fifth plurality of strand sections including individual strand sections 522A, 522B, and 522C and a sixth plurality of strand sections including individual strand sections 524A, 524B, and 524C. Each of the individual strand sections 522A, 522B, and 522C is a part of a fifth conductive layer between the inner circumference 570 and the outer circumference 575. Each of the individual strand sections 524A, 524B, and 524C is a part of a sixth conductive layer between the inner circumference 570 and the outer circumference 575.

The strand section 522A can be configured to the strand section 524B by via 550A, the strand section 524B can be configured to connect to the strand section 522B by via 550B, the strand section 522B can be configured to connect to the strand section 524C by via 550C, the strand section 524C can be configured to connect to the strand section 522C by via 550D, and the strand section 522C can be configured to connect to the strand section 524A by via 550E. The connection of the fifth plurality of strand sections including the individual strand sections 522A, 522B, and 522C and the sixth plurality of strand sections including the strand sections 524A, 524B, and 524C as described above can form a single or third turn around a core of a PCB transformer.

It should be noted that each of the three turns described above for the winding structure 500 can be interconnected with each other by vias 560 and 565. For example, the via 560 can be configured to connect the strand section 504A to the strand section 512A, thereby connecting the second and the third conductive layers. Additionally, the via 565 can be configured to connect the strand section 514A to the strand section 522A, thereby connecting the fourth and the fifth conductive layers. In this fashion, the three turns can be interconnected with each other across at least six different conductive layers, with each layer being embodied by one or more wires (e.g., one or more strand sections). Additionally, the three turns are shown in the winding structure 500 for exemplary purposes. The winding structure 500 can include more than three turns to substantially fill or cover an entire region or area of the circular winding region 590, similar to as depicted in the winding structure 400. During operation, current may enter through the first conductive layer corresponding to the strand section 502A and exit through the sixth conductive layer corresponding to the strand section 524A.

Each turn can also be rotated from each other based on a winding rotation angle θ₂. The winding rotation angle θ₂ can be defined by equation (2) below:

$${θ}_{2} = 2 π / ( N \times M \times P / 2 ) . \qquad ( 2 )$$

For the winding rotation angle θ₂, N refers to the total number of strands in parallel at the winding region 590, M refers to the total number of strand sections in each strand, and P refers to the total number of turns. This approach allows for creating additional space to accommodate extra vias, enabling the integration of multiple layers within a single PCB instead of requiring external connections for each turn. The total number of vias can be determined by factors such as the radius of the inner circle, clearance requirements in the PCB manufacturing process, and the via size. For designs with a higher number of vias, the use of through-hole vias may not be optimal, and buried vias can be considered to achieve better performance.

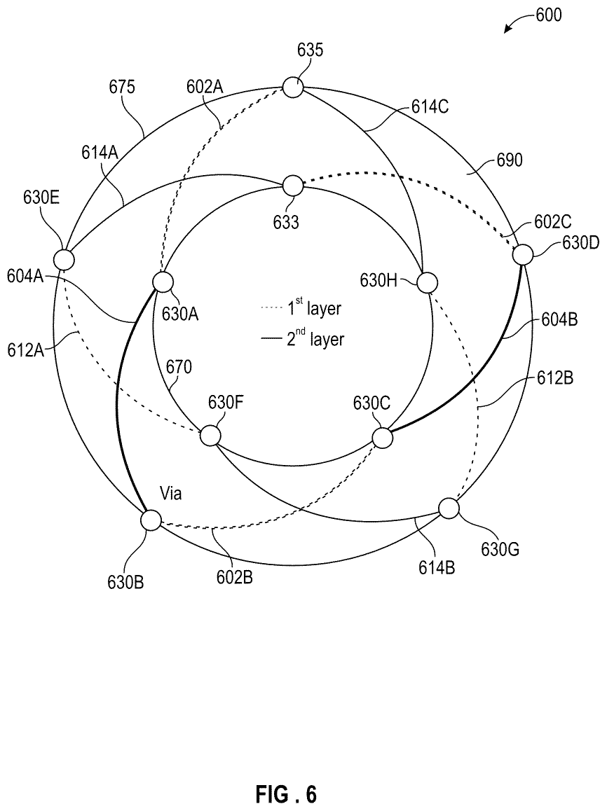

FIG. 6 depicts an example winding structure implementing multiple turns for a single strand according to various embodiments of the present disclosure. A winding structure 600 includes a toroidal or circular winding region 690, which is defined by an inner circumference 670 and an outer circumference 675. The winding structure 600 also includes two turns of a single strand with each turn corresponding to or extending through two conductive layers between the inner circumference 670 and the outer circumference 675. Each turn is defined by strand sections, and strand sections for a turn can be interconnected by vias in a similar fashion as described with respect to the interconnection of the strand sections in the winding structures 100-500. A description of each turn and its connection of strand sections is provided below.

A first turn of the winding structure 500 includes a first plurality of strand sections including individual strand sections 602A, 602B, and 602C and a second plurality of strand sections including individual strand sections 604A and 604B. Each of the individual strand sections 602A, 602B, and 602C is a part of a first conductive layer between the inner circumference 670 and the outer circumference 675, and each of the individual strand sections 604A and 604B is a part of a second conductive layer between the inner circumference 670 and the outer circumference 675.

The first turn can begin at via 635. For example, the strand section 602A can be configured to connect to the strand section 604A by via 630A, the strand section 604A can be configured to connect to the strand section 602B by via 630B, the strand section 602B can be configured to connect to the strand section 604B by via 630C, and the strand section 604B can be configured to connect to the strand section 602C by via 630D. The strand section 602C further extends to via 633, which can serve as an ending point of the first turn. The connection of the first plurality of strand sections including the individual strand sections 602A, 602B, and 602C and the second plurality of strand sections including the strand sections 604A and 604B as described above can form a single or first turn around a core of a PCB transformer.

A second turn of the winding structure 500 includes a third plurality of strand sections including individual strand sections 614A, 614B, and 614C and a fourth plurality of strand sections including individual strand sections 612A and 612B. Each of the individual strand sections 612A and 612B additionally forms or corresponds is a part of the first conductive layer between the inner circumference 670 and the outer circumference 675, and each of the individual strand sections 614A, 614B, and 614C additionally is a part of the second conductive layer between the inner circumference 670 and the outer circumference 675.

The second turn can begin at the via 633, which is an ending point for the first turn. For example, the strand section 614A can be configured to the strand section 612A by via 630E, the strand section 612A can be configured to connect to the strand section 614B by via 630F, the strand section 614B can be configured to connect to the strand section 612B by via 630G, and the strand section 612B can be configured to connect to the strand section 614C by via 630H, ending at the via 635, which is a starting point of the first turn. The connection of the third plurality of strand sections including the individual strand sections 614A, 614B, and 614C and the fourth plurality of strand sections including the strand sections 612A and 612B as described above can form a single or second turn around a core of a PCB transformer. The second turn begins at the ending point (e.g., the via 633) of the first turn and ends at the starting point (e.g., the via 635) of the first turn. The two turns are interconnected by the via 633 and 635 and form a single strand that extends between the first and the second conductive layers between the inner circumference 670 and the outer circumference 675. This approach enables the equivalent winding width to be reduced by half (e.g., as compared to the winding width corresponding to the winding structures 200 and 300). The reduction in losses may not be as significant when compared to the winding pattern of the winding structures 200 and 300. In one example, there was a 10% reduction in winding losses under the same turn conditions. With less strand sections (e.g., as compared to the strand sections for the winding structures 200 and 300), current distribution may not be as uniformly distributed. However, the overall loss, which includes DC and AC winding loss, can be optimized as the minimum within a given winding width.

In contrast to the winding structures 200 and 300, this connection method implementing two turns in two conductive layers can require that the strand section numbers be odd rather than an even number to ensure that one strand winds around the core two times and then comes back or terminates at the starting point as described above.

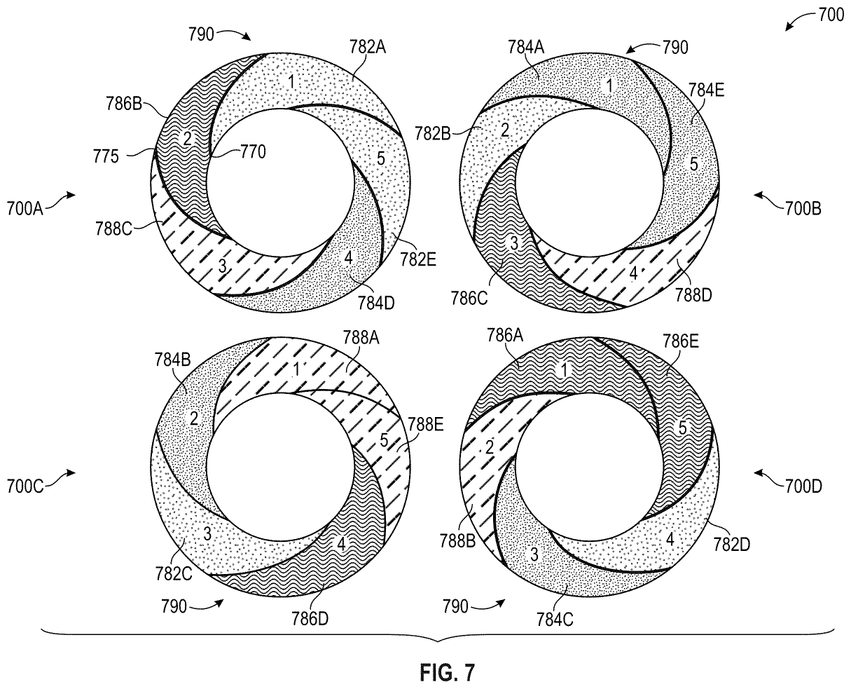

FIG. 7 depicts an example winding structure implementing multiple turns in multiple layers according to various embodiments of the present disclosure. A winding structure 700 provides an example of implementing four turns in four layers, with each partial winding structure representation (700A-700D) depicting how each strand segment of a turn is positioned within a toroidal or circular winding region 790, where the circular winding region 790 is defined by an inner circumference 770 and an outer circumference 775. For example, each turn can include five strand sections, and four of the five strand sections can each be a part of a different conductive layer, with the fifth strand completing the end of a turn at a same conductive layer as the first strand.

For example, the winding structure 700 includes a first turn that includes five individual strand sections 782A, 782B, 782C, 782D, and 782E, as shown in the four partial winding structure representations 700A-700D. The strand section 782A is a part of a first conductive layer as indicated by (1) in the partial winding structure representation 700A, the strand section 782B is a part of a second conductive layer as indicated by (2) in the partial winding structure representation 700B, the strand section 782C is a part of a third conductive layer as indicated by (3) in the partial winding structure representation 700C, the strand section 782D is a part of a fourth conductive layer as indicated by (4) in the partial winding structure representation 700D, and the strand section 782E is an additional part of the first conductive layer as indicated by (5) in the partial winding structure representation 700A. The strand section 782E, as the fifth strand section, completes the first turn at the first conductive layer. This structure arrangement or pattern is repeated for the other turns of the winding structure 700.

Additionally, the winding structure 700 includes a second turn that includes five individual strand sections 784A, 784B, 784C, 784D, and 784E, as shown in the four partial winding structure representations 700A-700D. The strand section 784A is a part of the first conductive layer as indicated by (1) in the partial winding structure representation 700B, the strand section 784B is a part of the second conductive layer as indicated by (2) in the partial winding structure representation 700C, the strand section 784C is a part of the third conductive layer as indicated by (3) in the partial winding structure representation 700D, the strand section 784D is a part of the fourth conductive layer as indicated by (4) in the partial winding structure representation 700A, and the strand section 784E is a part of the first conductive layer as indicated by (5) in the partial winding structure representation 700B. The strand section 784E, as the fifth strand section, completes the second turn at the first conductive layer.

Additionally, the winding structure 700 includes a third turn that includes five individual strand sections 786A, 786B, 786C, 786D, and 786E, as shown in the four partial winding structure representations 700A-700D. The strand section 786A is a part of the first conductive layer as indicated by (1) in the partial winding structure representation 700D, the strand section 786B is a part of the second conductive layer as indicated by (2) in the partial winding structure representation 700A, the strand section 786C is a part of the third conductive layer as indicated by (3) in the partial winding structure representation 700B, the strand section 786D is a part of the fourth conductive layer as indicated by (4) in the partial winding structure representation 700C, and the strand section 786E is a part of the first conductive layer as indicated by (5) in the partial winding structure representation 700D. The strand section 786E, as the fifth strand section, completes the third turn at the first conductive layer.

Additionally, the winding structure 700 includes a fourth turn that includes five individual strand sections 788A, 788B, 788C, 788D, and 788E, as shown in the four partial winding structure representations 700A-700D. The strand section 788A is a part of the first conductive layer as indicated by (1) in the partial winding structure representation 700C, the strand section 788B is a part of the second conductive layer as indicated by (2) in the partial winding structure representation 700D, the strand section 788C is a part of the third conductive layer as indicated by (3) in the partial winding structure representation 700A, the strand section 788D is a part of the fourth conductive layer as indicated by (4) in the partial winding structure representation 700B, and the strand section 788E is a part of the first conductive layer as indicated by (5) in the partial winding structure representation 700C. The strand section 788E, as the fifth strand section, completes the fourth turn at the first conductive layer.

It should be noted that in each of the winding structures 100-700, each strand section is identical or substantially identical in shape, structure, and length to another strand section within the same winding structure. For example, in the winding structure 500, each strand section such as the strand section 502A, 512A, 522A, 514A, 524A, and 504A, etc., is identical or substantially identical in shape, structure, and length with each other.

This approach of implementing multiple turns in multiple conductive layers, or implementing the same amount of turns in the same number of conductive layers (e.g., four turns in four conductive layers, five turns in five conductive layers, six turns in six conductive layers, etc.) can create a stronger interwoven effect between multiple layers. In comparison to traditional Litz wires, the interwoven effect per turn may not be as pronounced. However, this approach fosters a stronger interwoven effect among different turns, a characteristic not attainable with traditional Litz wires. From a construction perspective, the strand section layout is similar to the strand section layout in the winding structure 600 in FIG. 6. Variations can exist in the via connections, aimed at achieving a more effective flux cancellation.

The embodiments include integrating a PCB Litz wire concept for PCB or planar transformers. The embodiments can achieve a more uniform current distribution in the corresponding PCB windings. Although the DC winding resistance can increase due to the zig-zag pattern and clearance requirement, the winding structures of the embodiments can significantly reduce AC resistance by utilizing multiple parallel strands to mitigate the impact of skin effect and proximity effect with a much more uniform current distribution. Additionally, the circular winding shape and curved strands or strand sections fully utilize the copper area or lower resistance compared to other methods. The circular shape also provides optimal symmetry, ensuring that each strand has the same length and width, resulting in identical impedance, and making layout and optimization processes much easier. Core loss and winding loss optimization process can additionally be decoupled with based on the winding structures of the embodiments. These structures can provide the extra benefit on the construction of multiple turns.

Unlike other PCB Litz concepts, the winding structures of the embodiments avoid connecting each turn out of the PCB. Different turns can be linked internally inside one PCB, which can make the fabrication and assembly much easier. For example, A 30 kW PCB winding based resonant converter was designed based on the proposed structure. The winding loss was reduced by over 40% compared to a traditional PCB winding based transformer under the same footprint. The thermal distribution and management of the winding structures of the embodiments are better than conventional state-of-art PCB winding based transformer design. As a result, the winding structures of the embodiments have great potential in high current PCB winding based transformer and inductor design applications.

The features, structures, or characteristics described above may be combined in one or more embodiments in any suitable manner, and the features discussed in the various embodiments are interchangeable, if possible. In the following description, numerous specific details are provided in order to fully understand the embodiments of the present disclosure. However, a person skilled in the art will appreciate that the technical solution of the present disclosure may be practiced without one or more of the specific details, or other methods, components, materials, and the like may be employed. In other instances, well-known structures, materials, or operations are not shown or described in detail to avoid obscuring aspects of the present disclosure.

Although the relative terms such as “on,” “below,” “upper,” and “lower” are used in the specification to describe the relative relationship of one component to another component, these terms are used in this specification for convenience only, for example, as a direction in an example shown in the drawings. It should be understood that if the device is turned upside down, the “upper” component described above will become a “lower” component. When a structure is “on” another structure, it is possible that the structure is integrally formed on another structure, or that the structure is “directly” disposed on another structure, or that the structure is “indirectly” disposed on the other structure through other structures.

In this specification, the terms such as “a,” “an,” “the,” and “said” are used to indicate the presence of one or more elements and components. The terms “comprise,” “include,” “have,” “contain,” and their variants are used to be open ended, and are meant to include additional elements, components, etc., in addition to the listed elements, components, etc. unless otherwise specified in the appended claims. If a component is described as having “one or more” of the component, it is understood that the component can be referred to as “at least one” component.

The terms “first,” “second,” etc. are used only as labels, rather than a limitation for a number of the objects. It is understood that if multiple components are shown, the components may be referred to as a “first” component, a “second” component, and so forth, to the extent applicable.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

The above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, at least the following is claimed:

1. A winding structure for a printed circuit board (PCB) transformer, comprising:
a circular winding region defined by an outer circumference and an inner circumference;
a first plurality of strand sections in a first conductive layer, wherein each strand section of the first plurality of strand sections extends from the outer circumference to the inner circumference;
a second plurality of strand sections in a second conductive layer, wherein each strand section of the second plurality of strand sections extends from the outer circumference to the inner circumference; and
a plurality of vias that connects the first plurality of strand sections to the second plurality of strand sections to form a single strand through the circular winding region.

2. The winding structure of claim 1, wherein the single strand is positioned according to a winding rotation angle based at least in part on a total number of strands in the winding structure and a total number of strand sections per strand.

3. The winding structure of claim 1, wherein each strand section of the first plurality of strand sections is connected to a respective strand section of the second plurality of strand sections by a via among the plurality of vias of the winding structure.

4. The winding structure of claim 3, wherein for an individual strand section of the first plurality of strand sections connected to a respective strand section of the second plurality of strand sections by a via of the plurality of vias, the two individual strand sections are symmetric with each other about a center or a radial axis of the circular winding region.

5. The winding structure of claim 1, further comprising:
a second strand rotated as compared to the first strand by a winding rotation angle, the winding rotation angle determined based at least in part on a number of total strands across the circular winding region and a number of total strand sections in the first strand or the second strand.

6. The winding structure of claim 5, wherein:
the winding structure comprises N total strands, the N total strands comprising the first strand and the second strand; and
each strand of the N total strands is rotated from each other by the winding rotation angle.

7. The winding structure of claim 6, wherein each strand of the N total strands is parallel and non-intersecting with each other.

8. The winding structure of claim 6, wherein the N total strands form an interwoven structure over a substantial entirety of the circular winding region.

9. The winding structure of claim 6, wherein each strand of the N total strands forms at least one different conductive layer from another strand of the N total strands.

10. The winding structure of claim 6, wherein the N total strands form a single turn around a core.

11. The winding structure of claim 6, wherein each strand of the N total strands forms two different conductive layers from another strand of the N total strands.

12. The winding structure of claim 1, wherein each strand section of the first plurality of strand sections is substantially identical in structure and length to each strand section of the second plurality of strand sections.

13. The PCB transformer of claim 1, wherein the single strand forms at least two turns around a core.

14. The PCB transformer of claim 1, wherein each of the first plurality of strand sections and the second plurality of strand sections is arc-like in shape.

15. A winding structure for a printed circuit board (PCB) transformer, comprising:
a circular winding region defined by an outer circumference and an inner circumference; and
a strand comprising a first turn and a second turn around a core, the strand extending between the outer circumference and the inner circumference in a sequential manner, wherein:
the first turn comprises a first plurality of strand sections interconnected by a plurality of vias;
the second turn comprises a second plurality of strand sections interconnected by a plurality of vias; and
the first turn and the second turn are interconnected by one or more vias.

16. The winding structure of claim 15, wherein:
each strand section interconnected among the first plurality of strand sections alternates sequentially between extending from the outer circumference to the inner circumference and from the inner circumference to the outer circumference; and
each strand section interconnected among the second plurality of strand sections alternates sequentially between extending from the outer circumference to the inner circumference and from the inner circumference to the outer circumference.

17. The winding structure of claim 15, wherein:
each strand section interconnected among the first plurality of strand sections alternates sequentially between being in a first conductive layer or a second conductive layer; and
each strand section interconnected among the second plurality of strand sections alternates sequentially between being in a first conductive layer or a second conductive layer.

18. The winding structure of claim 15, wherein each strand section of the first plurality of strand sections and the second plurality of strand sections is arc-like or curved in shape.

19. The winding structure of claim 15, wherein each strand section of the first plurality of strand sections is substantially identical in structure and length to each strand section of the second plurality of strand sections.

20. The winding structure of claim 15, wherein for an individual strand section of the first plurality of strand sections connected to a respective strand section of the second plurality of strand sections by a via of the one or more vias, the two individual strand sections are symmetric with each other about a center or a radial axis of the circular winding region.
